(19) United States
(12) Patent Application Publication
(10) Pub. No.: US 2019/0210029 A1
(43) Pub. Date: Jul. 11, 2019

(54) TEMPERATURE-CONTROLLED HEATING PANEL, PREPARATION METHOD THEREOF AND HEATING METHOD

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Zongze HE, Beijing (CN); Shuo LI, Beijing (CN); Jianguang YANG, Beijing (CN); Zhenghua LU, Beijing (CN); Yuxuan CHEN, Beijing (CN); Liang ZHANG, Beijing (CN); Feng LONG, Beijing (CN)

(21) Appl. No.: 16/233,261

(22) Filed: Dec. 27, 2018

(30) Foreign Application Priority Data
Jan. 9, 2018 (CN) 201810018596.6

(51) Int. Cl. B01L 7/00; G01K 7/01

(52) U.S. Cl. CPC B01L 7/52; B01L 2300/1827; G01K 7/015

(57) ABSTRACT

The present disclosure provides a temperature-controlled heating panel including: a substrate; at least one heating element provided in a first region on the substrate; at least one temperature sensing element provided in a second region on the substrate and located in a heat radiation area of the at least one heating element; a controller configured to control the temperature of the heat radiation area by using the at least one heating element based on the temperature of the heat radiation area sensed by the at least one temperature sensing element.

### CROSS-REFERENCE TO RELATED APPLICATION

The present application claims the priority of the Chinese Patent Application No. 201810018596.6 filed on Jan. 9, 2018, the entire disclosure of which is hereby incorporated by reference in its entirety.

### TECHNICAL FIELD

The present disclosure relates to the field of biomedicine and chemical engineering, and in particular, to a temperature-controlled heating panel, a preparation method thereof, and a heating method.

### BACKGROUND

Precise temperature control of liquid reagents is often required in the fields of biomedicine and chemical engineering. The current temperature control methods mainly include a temperature control method for a certain volume of reagent and an environment temperature control method. As experimental conditions are severe, it is necessary to control temperature of a certain amount of reaction reagent droplet for a specific time. Thus, temperature control operations that are machined, programmed, and less human intervention are widely needed. However, a temperature-controlled heating panel, a preparation method thereof, and a method currently used for heating reagent droplet still need to be improved.

### SUMMARY

The present disclosure provides a temperature-controlled heating panel, a preparation method thereof, and a heating method.

In an embodiment, a temperature-controlled heating panel is provided to include a substrate; at least one heating element provided in a first region on the substrate; at least one temperature sensing element provided in a second region different from the first region on the substrate and located in a heat radiation area of the at least one heating element for sensing a temperature of the heat radiation area; and a controller configured to control, based on the temperature of the heat radiation area sensed by the at least one temperature sensing element, the temperature of the heat radiation area by using the at least one heating element.

In an embodiment, the at least one heating element includes a plurality of heating elements and the at least one temperature sensing element includes a plurality of temperature sensing elements, and the plurality of heating elements are arranged in an array on the substrate and the plurality of the temperature sensing elements are arranged in an array on the substrate.

In an embodiment, the plurality of heating elements include a first heating element, a second heating element, a third heating element, and a fourth heating element provided on the substrate and equally spaced apart from each other; the plurality of temperature sensing elements include a first temperature sensing element, a second temperature sensing element, a third temperature sensing element, and a fourth temperature sensing element arranged in an array; and the first temperature sensing element is provided between the first heating element and the second heating element, the second temperature sensing element and the third temperature sensing element are provided between the second heating element and the third heating element, and the fourth temperature sensing element is provided between the third heating element and the fourth heating element.

In an embodiment, the controller includes a temperature control circuit connected to the at least one heating element and configured to adjust a current applied to the at least one heating element.

In an embodiment, the heat radiation area of each of the at least one heating element is in a range from 0.5 mm² to 1.5 mm².

In an embodiment, the heat radiation area of each of the at least one heating element is in a range from 0.8 mm×0.8 mm to 1.2 mm×1.2 mm.

In an embodiment, the at least one heating element each is a metal wire and is arranged on the substrate in a meander line shape or strip-shape.

In an embodiment, a width of an orthographic projection of the metal wire on the substrate is in a range from 0.7 mm to 1.1 mm.

In an embodiment, each of the at least one temperature sensing element is a temperature sensing diode, and the temperature sensing diode includes a first end provided on the substrate; a PN junction provided on a side of the first end away from the substrate; and a second end provided on a side of the PN junction away from the first end.

In an embodiment, each of the at least one heating element is a metal wire, and the metal wire is provided on a same layer as the second end.

In an embodiment, the controller further includes a constant current circuit including a constant current source, two ends of the constant current source being respectively coupled to the first and second ends of the at least one temperature sensing diode for applying a constant current to the at least one temperature sensing diode.

In an embodiment, the constant current circuit further includes a voltage detecting element having a first end and a second end, and the first end and the second end of the voltage detecting element are respectively connected to the first end and the second end of the at least one temperature sensing diode for sensing a voltage of the at least one temperature sensing diode.

In an embodiment, the temperature-controlled heating panel further includes a buffer layer, an organic film layer, and an isolation layer provided on the substrate including the PN junction; and a protective layer provided on the second end and the metal wire, and the second end is connected to one end of the PN junction via a through hole provided in the buffer layer, the organic film layer, and the isolation layer.

In an embodiment, the buffer layer, the isolation layer, and the protective layer are formed of nitrogen-silicon compound, and the organic film layer is formed of resin.

In an embodiment, a method of preparing a temperature-controlled heating panel is provided to include steps of providing at least one heating element in a first region on a substrate; providing at least one temperature sensing element in a second region different from the first region on the substrate, and the at least one temperature sensing element being provided in a heat radiation area of the at least one heating element for sensing a temperature of the heat radiation area; and providing a temperature controller, the temperature controller being configured to control, based on the temperature of the heat radiation area sensed by the at least one temperature sensing element, the temperature of the heat radiation area by using the at least one heating element.

In an embodiment, the at least one temperature sensing element is a temperature sensing diode including a first end, a PN junction, and a second end, and the at least one heating element is a metal wire; and the step of providing the at least one heating element in the first region on the substrate and providing the at least one temperature sensing element in the second region different from the first region on the substrate includes steps of forming a first metal layer on the substrate, and forming, by a first patterning process, a pattern of the first end; forming a first amorphous silicon layer and a second amorphous silicon layer sequentially on a side of the first end away from the substrate, and forming, by a second patterning process, a pattern of the PN junction; and forming a second metal layer on a side of the PN junction away from the first end, and forming, by a third patterning process, patterns of the second end and the metal wire such that the second end is connected to one end of the PN junction.

In an embodiment, after forming the pattern of the PN junction and before forming the patterns of the second end and the metal wire, the method further includes steps of forming a buffer layer, an organic film layer, and an isolation layer sequentially; and forming a through hole in the buffer layer, the organic film layer, and the isolation layer to expose a portion of a top surface of the PN junction such that the second end is connected to one end of the PN junction via the through hole.

In an embodiment, after forming the patterns of the second end and the metal wire, the method further includes forming a protective layer.

In an embodiment, a heating method by using a temperature-controlled heating panel is provided, and the temperature-controlled heating panel includes a substrate; at least one heating element provided in a first region on the substrate; at least one temperature sensing element provided in a second region different from the first region on the substrate and located in a heat radiation area of the at least one heating element for sensing a temperature of the heat radiation area: and a controller configured to control, based on the temperature of the heat radiation area sensed by the at least one temperature sensing element, the temperature of the heat radiation area by using the at least one heating element, and the method includes a step of adjusting, by using the controller, a current applied to the at least one heating element based on the temperature of the heat radiation area sensed by the at least one temperature sensing element.

In an embodiment, the step of adjusting, by using the controller, a current applied to the at least one heating element based on the temperature of the heat radiation area sensed by the at least one temperature sensing element includes steps of increasing, by using a temperature control circuit in the controller, the current applied to the at least one heating element when the temperature of the heat radiation area sensed by the at least one temperature sensing element is lower than a temperature to which the heat radiation area needs to be heated; and decreasing, by using the temperature control circuit, the current applied to the at least one heating element when the temperature of the heat radiation area sensed by the at least one temperature sensing element is higher than the temperature to which the heat radiation area needs to be heated.

### BRIEF DESCRIPTION OF THE DRAWINGS

The above and/or additional aspects and advantages of the present disclosure will become apparent and readily understood from the description of the embodiments in combination with the following drawings:

FIG. 1 is a schematic structural view of a temperature-controlled heating panel according to an embodiment of the present disclosure:

FIG. 2 is a schematic structural view of a temperature-controlled heating panel according to an embodiment of the present disclosure:

FIG. 3 is a schematic structural view of a controller according to an embodiment of the present disclosure;

FIG. 4 is a schematic cross-sectional view of a temperature-controlled heating panel in accordance with an embodiment of the present disclosure;

FIG. 5 is a schematic diagram of a constant current circuit according to an embodiment of the present disclosure;

FIG. 6 is an electrical characteristic graph of a temperature sensing element according to an embodiment of the present disclosure; and

FIG. 7 is a schematic flow chart of a preparation method of a temperature-controlled heating panel according to an embodiment of the present disclosure.

### DETAILED DESCRIPTION

Embodiments of the present disclosure are described in detail below, and examples of the embodiments are illustrated in the drawings, in which the same or similar reference numerals are used to refer to the same or similar elements or elements having the same or similar functions. The embodiments described below with reference to the accompanying drawings are intended to be illustrative only, and the disclosure is not limited thereto.

At present, devices and methods for heating reagent droplet cannot achieve precise temperature control of small area, primarily due to defects in devices and methods for heating reagent droplet.

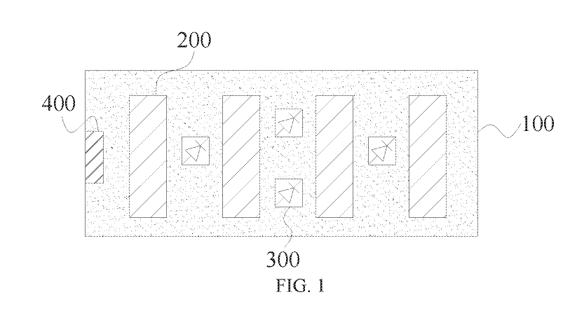

According to one aspect of the present disclosure, a temperature-controlled heating panel is provided. According to an embodiment of the present disclosure, referring to FIG. 1, the temperature-controlled heating panel includes a substrate 100, a plurality of heating elements 200, a plurality of temperature sensing elements 300, and a controller 400. The heating element 200 is provided on the substrate 100 and the plurality of heating elements 200 are arranged in an array. The plurality of temperature sensing elements 300 are provided near the heating elements 200 on the substrate 100. For example, the temperature sensing element 300 may be in heat radiation areas of the heating elements 200 and the plurality of temperature sensing elements 300 are arranged in an array. The controller 400 is configured to control heating temperature of the heating elements 200 according to the temperature sensed by the temperature sensing element 300. Thus, the temperature-controlled heating panel can achieve precise control of temperature above environment temperature for smaller areas.

For example, in the top view of FIG. 1, the plurality of heating elements 200 (the temperature-controlled heating panel shown in FIG. 1 includes four heating elements 200) having the same structure and being strip-shaped are provided on the substrate 100 and equally spaced apart from each other. The plurality of temperature sensing elements 300 (the temperature-controlled heating panel shown in FIG. 1 includes four temperature sensing elements 300) have the same structure (which may be temperature sensing diodes having a same structure) and are arranged in an array on the substrate 100. As shown in FIG. 1, one temperature sensing diode 300 or two temperature sensing diodes 300 may be provided between every two adjacent heating elements 200. But the present disclosure is not limited thereto, more temperature sensing elements are distributed on the temperature-controlled heating panel, the higher accuracy of temperature measurement is achieved.

For easy understanding, the principle of the temperature-controlled heating panel according to an embodiment of the present disclosure will be briefly described below.

As mentioned above, precise temperature control of the reagent droplet is often required in the fields of biomedicine and chemical engineering. Current temperature control methods mainly include a temperature control method for a certain volume of reagent and an environment temperature control method. As for the temperature control method for a certain volume of reagent, when the amount of the reagent to be heated is too small, it is impossible to control the temperature of a reagent droplet with small volume to be heated since the heating volume standard is not reached. As for the environment temperature control method, when the temperature to be controlled is higher than environment temperature, it is impossible to control the temperature of a reagent droplet to be heated above the environment using the above method, thus precise temperature control cannot be achieved.

According to an embodiment of the present disclosure, by directly fabricating the heating elements 200 and the temperature sensing elements 300 on the substrate 100, a small area on the substrate 100 is heated by the heating element 200, and based on a characteristic that voltage-current (V-I) characteristic of the temperature sensing element 300 in a heat radiation area of the heating element 200 changes with temperature changing, temperature may be sensed and controlled and then precise temperature control for the area where a small droplet is located can be achieved. Specifically, the heating element 200 is heated by a controller 400, and a constant current is applied to the temperature sensing element 300 based on the characteristic that the voltage-current characteristic of the temperature sensing element 300 changes with temperature changing, a voltage of the temperature sensing element 300 at the constant current is obtained, and the temperature sensed by the temperature sensing element 300 is obtained according to the current and the voltage of the temperature sensing element 300. The sensed temperature is the heating temperature of the heating element 200, and the heating temperature of the heating element 200 is adjusted based on the sensed temperature, thereby precise temperature control for small area is achieved.

Various structures of the temperature-controlled heating panel will be described in detail below according to embodiments of the present disclosure.

According to an embodiment of the present disclosure, the heat radiation area of the heating element 200 is, for example, 0.5 mm²-1.5 mm². According to a specific embodiment of the present disclosure, the heat radiation area of the heating element 200 may be 0.8 mm×0.8 mm-1.2 mm×1.2 mm. Thus, the temperature-controlled heating panel can achieve heating of a small area and even heating of a single droplet.

Type of the heating elements is not limited in the present disclosure and may be designed by those skilled in the art according to specific conditions. For example, according to an embodiment of the present disclosure, the heating element 200 may be a metal wire having good thermal conductivity, and thus heating performance of the temperature-controlled heating panel may be ensured. Moreover, in preparing the temperature-controlled heating panel, the metal wire can be formed synchronously with the temperature sensing element, thereby simplifying the production process and saving production cost. Type of material of the metal wire is not particularly limited and may be selected by those skilled in the art according to the specific conditions.

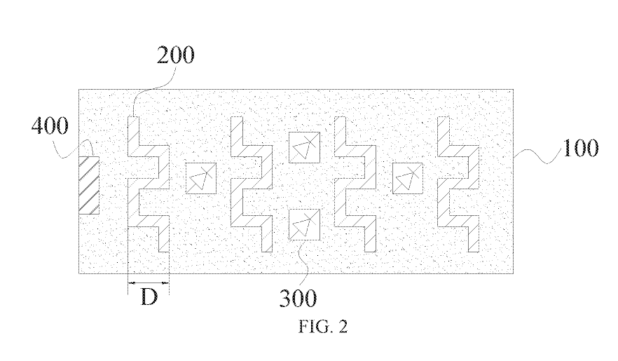

According to an embodiment of the present disclosure, referring to FIG. 2, the metal wire (i.e., the heating element 200) is arranged in a meander line on the substrate 100, and more specifically, the angle of the meander line may be 90 degrees, thereby the heating is even. According to an embodiment of the present disclosure, the width (i.e., “D” in FIG. 2) of the area where the metal wire is projected on the substrate 100 may be 0.7 mm to 1.1 mm. Thus, evenly heating of a small area can be achieved. It should be noted that the “D” here is not the width of a single wire, but the width of the area covered by the metal wire in a meander line arrangement.

In the embodiment shown in FIG. 2, similar to the plurality of the strip-shaped heating elements 200 of FIG. 1, a plurality of heating elements 200 arranged in a meander line are spaced apart from each other on the substrate 100, and a plurality of temperature sensing elements 300 are distributed in the heat radiation areas formed by the plurality of heating elements 200 for sensing the temperature of the area in which it is located.

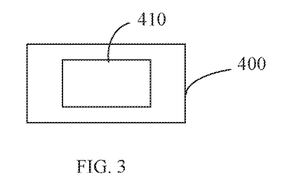

According to an embodiment of the present disclosure, the controller 400 may include a temperature control circuit 410 (referring to FIG. 3) connected to the metal wire and configured to adjust a current applied to the metal wire. The controller 400 may also include a receiving circuit for obtaining the temperature sensed by the temperature sensing element, and the temperature control circuit 410 adjusts the current applied to the heating element (e.g., the metal wire) according to the received temperature sensed by the temperature sensing element to control the heating temperature of the heating element. The temperature control circuit 410 can be used to control the current flowing through the metal wire, thereby controlling the heating temperature of the metal wire. According to an embodiment of the present disclosure, a current is applied to the metal wire by the temperature control circuit 410 to achieve heating, and therefore, the small area can be heated to a temperature above the environment temperature, thereby precise temperature control for small area is achieved.

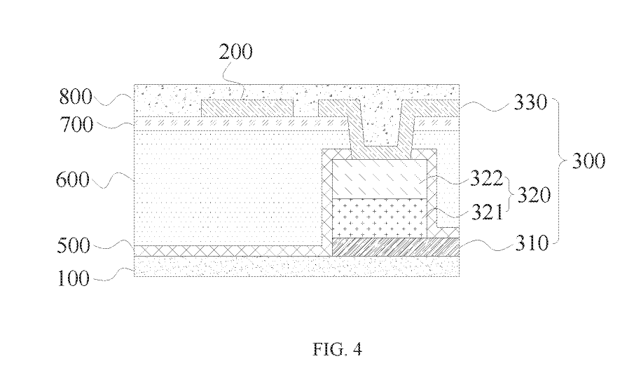

According to an embodiment of the present disclosure, referring to FIG. 4, the temperature sensing element 300 may be a temperature sensing diode including a first end 310, a PN junction 320, and a second end 330. The first end 310 is provided on a substrate 100, the PN junction 320 is provided on a side of the first end 310 away from the substrate 100, and the second end 330 is provided on a side of the PN junction 320 away from the first end 310. Thereby, the heating temperature of the metal wire can be sensed by the temperature sensing diode. According to an embodiment of the present disclosure, composition of the PN junction 320 is not particularly limited as long as temperature sensing can be achieved. For example, according to a specific embodiment of the present disclosure, the PN junction 320 may include a first amorphous silicon layer 321 and a second amorphous silicon layer 322, and the first amorphous silicon layer 321 may be P-type amorphous silicon, and the second amorphous silicon layer 322 may be N-type amorphous silicon. According to an embodiment of the present disclosure, the first end 310 and the second end 330 may be made of a metal material, and the first end 310 and the second end 330 may be made of the same kind of metal or different kinds of metal, which is not limited by the present disclosure. Type of Materials forming the first end and the second end are not limited by the present disclosure and may be selected by those skilled in the art according to specific conditions.

According to an embodiment of the present disclosure, the metal wire (i.e., the heating element 200) may be provided in the same layer as the second end 330, and the metal wire and the second end 330 are formed by a same patterning process. According to an embodiment of the present disclosure, the metal wire and the second end 330 may be made of the same kind of metal material. Thereby, one metal layer may be provided during the preparation of the temperature-controlled heating panel, and then the metal wire and the second end are formed simultaneously by the same patterning process, which simplifies the production process, saves production costs, and reduces costs of the temperature-controlled heating panel.

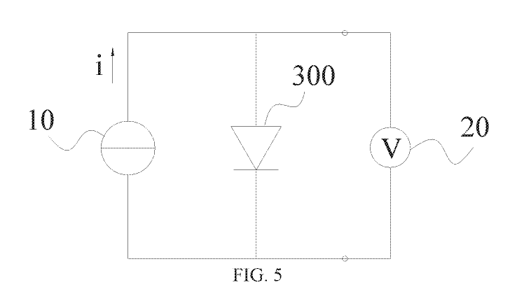

According to an embodiment of the present disclosure, referring to FIG. 5, the controller 400 may further include a constant current circuit including a constant current source 10 and a voltage detecting element 20, and configured to make the current flowing through the temperature sensing diode (i.e., the temperature sensing element 300) constant and obtain the voltage of the temperature sensing diode by the voltage detecting element 20. Thus, the temperature sensed by the temperature sensing diode may be obtained by applying the constant current to the temperature sensing diode and obtaining the voltage of the temperature sensing diode at the constant current.

According to an embodiment of the present disclosure, the principle of the temperature sensing diode for sensing temperature is as follows.

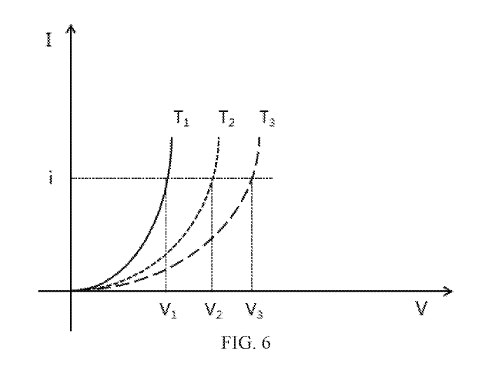

Referring to FIG. 6, the constant current circuit is used to apply the constant current to the temperature sensing diode, and the voltage detecting element is used to obtain the voltage of the temperature sensing diode at the constant current. According to the constant current and the voltage obtained at the constant current, the temperature sensed by the temperature sensing diode can be obtained. For example, according to an embodiment of the present disclosure, a constant current “I” is applied to the temperature sensing diode, and it is detected that the voltage at the constant current “I” is V₁, and then the temperature sensed by the temperature sensing diode can be obtained as T₁. It should be noted that the selection of constant current should be reasonable: that is, under the selected constant current, voltages, corresponding to different temperatures, are different significantly, and the temperature sensed by the temperature sensing diode can be easily determined by the voltage. As shown in FIG. 6, when the current applied to the temperature sensing diode is smaller than the current “I”, the voltage of the temperature sensing diode changes small when the environment temperature changes, when the current applied to the temperature sensing diode is greater than the current “I” (for a specific temperature, when the current continues to increase, the voltage of the temperature-sensitive diode will no longer increase significantly), the environment temperature will no longer significantly affect the voltage of the temperature sensing diode: in this case, when the current continues to increase, temperature sensing sensitivity will not be significantly increased.

According to an embodiment of the present disclosure, a current is applied to the metal wire by the temperature control circuit 410, the metal wire generates heat after the current flows through it; and a constant current is applied to the temperature sensing diode by the constant current circuit 410, and the temperature sensed by the temperature sensing diode is obtained by detecting the voltage of the temperature sensing diode, in which the temperature sensed by the temperature sensing diode is the heating temperature from the metal wire. The controller controls the temperature control circuit 410 to adjust the current applied to the metal wire by comparing the temperature sensed by the temperature sensing diode with the temperature to which the small area around the metal wire needs to be heated up, thereby achieving a precise control of the temperature. For example, according to an embodiment of the present disclosure, when the temperature sensed by the temperature sensing diode is lower than the temperature to which the small area around the metal wire needs to be heated up, the temperature control circuit 410 increases the current applied to the metal wire to increase the temperature. When the temperature sensed by the temperature sensing diode is higher than the temperature to which the small area around the metal wire needs to be heated up, the temperature control circuit 410 may decreases the current applied to the metal wire to reduce the heating temperature. According to an embodiment of the present disclosure, the temperature-controlled heating panel can be used to heat a small area around the metal wire to a predetermined temperature, and the heating temperature can be adjusted at any time during the heating process.

According to an embodiment of the present disclosure, referring to FIG. 4, the temperature-controlled heating panel is formed through the following steps. In a first step, the first end 310 is formed in a second region on the substrate 100. For example, a first metal layer is formed on the substrate 100 and a pattern of the first end 310 is formed through a first patterning process. In a second step, the PN junction 320 is formed on the first end 310. For example, a first amorphous silicon layer (e.g., P+ type amorphous silicon layer) and a second amorphous silicon layer (e.g., N+ type amorphous silicon layer) are deposited on the formed pattern of the first end 310: and then the pattern of the PN junction is formed through a second patterning process. For example, as shown in FIG. 4, the PN junction 320 is placed on the first end 310 and covers a portion of the first end 310. In a third step, a buffer layer 500, an organic film layer 600 (for example, a planarized organic film layer 600 here), and an isolation layer 700 are deposited on the substrate on which the first end 310 and the PN junction 320 are formed. In a fourth step, the buffer layer 500, the organic film layer 600, and the isolation layer 700 are etched to form a through hole, and the top surface of the PN junction 320 is exposed by the through hole. In the fifth step, the heating element 200 is formed on the isolation layer 700 in the first region and a second metal layer is formed in the second region. The patterns of the second end 330 and the heating element 200 are formed through a third patterning process, in which the second end 330 is located on the isolation layer 700, covers an inner sidewall of the through hole, and is in contact with the PN junction 320, and the heating element 200 is spaced apart and insulated from the second end 330; In a sixth step, a protective layer 800 is deposited on the isolation layer 700, the heating element 200, and the second end 330. The buffer layer 500 provided between the organic film layer 600 and the substrate 100 may increase adhesion between the organic film layer and the substrate, and the organic film layer 600 may be function as a planarization layer. According to an embodiment of the present disclosure, the buffer layer 500, the isolation layer 700, and the protective layer 800 may be formed of a silicon nitride compound (SiNₓ), and the organic film layer 600 may be formed of a resin.

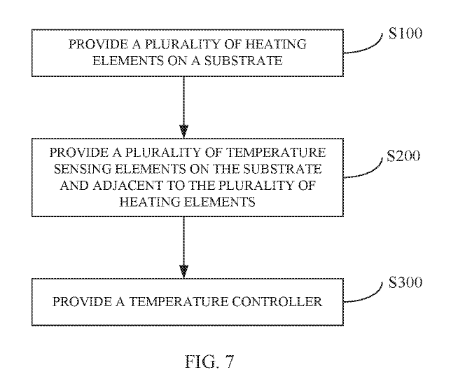

In another aspect of the present disclosure, the present disclosure provides a method of preparing a temperature-controlled heating panel. According to an embodiment of the present disclosure, the temperature-controlled heating panel prepared by the method may be the temperature-controlled heating panel described above. Thus, the temperature-controlled heating panel prepared by the method may have the features and advantages of temperature-controlled heating panel as described above, which will not be repeated. According to an embodiment of the present disclosure, referring to FIG. 7, the method includes following steps.

In Step 100, at least one heating element is provided on a substrate.

According to an embodiment of the present disclosure, in this step, a plurality of heating elements are provided on the substrate. Heat radiation area, type, and arrangement of the heating elements have been described in detail above, and will not be repeated here. For example, according to an embodiment of the present disclosure, the heat radiation area of the heating element is 0.8 mm×0.8 mm-1.2 mm×1.2 mm. Thus, the temperature-controlled heating panel may achieve heating for a small area and even heating a single droplet. According to an embodiment of the present disclosure, the heating element may be a metal wire, and the metal wire may be formed in synchronization with the temperature sensing element in a subsequent preparation process, which simplifies the production process and saves production costs. According to an embodiment of the present disclosure, the plurality of heating elements are arranged in an array on the substrate, and a single heating element may be arranged in a meander line. Thereby, a uniform heating result can be obtained.

In Step 200, at least one temperature sensing element is provided on the substrate, and the temperature sensing element is provided adjacent to the heating element, for example, the temperature sensing element is in the heat radiation area of the heating element.

According to an embodiment of the present disclosure, in this step, a plurality of temperature sensing elements are provided on the substrate, and the temperature sensing elements are provided adjacent to the heating elements. According to an embodiment of the present disclosure, the temperature sensing element may be a temperature sensing diode including a first end, a PN junction, and a second end. Therefore, the heating temperature of the metal wire may be sensed by the temperature sensing diode.

According to an embodiment of the present disclosure, the metal wire is provided in the same layer as the second end, thereby the metal wire and the second end can be obtained simultaneously, which simplifies production process and saves production costs. According to an embodiment of the present disclosure, the temperature sensing diode and the metal wire are formed through the following steps. Firstly, a first metal layer is evaporated on the substrate, and then the first end is formed by using a first patterning process on the first metal layer. Secondly, a first amorphous silicon layer and a second amorphous silicon layer are sequentially deposited on a side of the first end away from the substrate, and then the PN junction is formed by using a second patterning process on the first amorphous silicon layer and the second amorphous silicon layer. Thirdly, a second metal layer is evaporated on a side of the PN junction away from the first end, and then the second end and the metal wire are formed by using a third patterning process on the second metal layer, as shown in FIG. 4. The principle of the temperature sensing diode has been described in detail above and will not be repeated here.

Type of the first patterning process, the second patterning process, and the third patterning process is not particularly limited, and may be selected by those skilled in the art according to specific conditions. For example, according to an embodiment of the present disclosure, the first patterning process may be a photolithography process, and the first metal layer is patterned by exposure, development, etching, etc., to form the first end. The second patterning process and the third patterning process may also employ a photolithography process to form a PN junction and a second end, a wire, respectively, as described above with reference to FIG. 4.

In Step 300, a temperature controller is provided.

According to an embodiment of the present disclosure, in this step, a temperature controller is provided. According to an embodiment of the present disclosure, the temperature controller includes a temperature control circuit 410 and a constant current circuit (as shown in FIG. 5). The temperature control circuit 410 is configured to adjust the current applied to the metal wire. The temperature control circuit 410 can be used to control the current flowing through the metal wire, thereby controlling the heating temperature of the metal wire. The constant current circuit includes a constant current source 10 and a voltage detecting element 20. The constant current circuit is configured to allow the current flowing through the temperature sensing diode to be constant, and obtain the voltage of the temperature sensing diode by using the voltage detecting element, as shown in FIG. 5. In particular, both ends of each of the constant current source 10 and the voltage detecting 20 are connected to both ends of the temperature sensing diode 300, respectively. Thus, the temperature sensed by the temperature sensing diode is obtained by applying a constant current to the temperature sensing diode and obtaining the voltage of the temperature sensing diode at the constant current. The principle of the controller has been described in detail above and will not be repeated here.

According to an embodiment of the present disclosure, the method may further include providing a buffer layer on a side of the PN junction away from the substrate, providing an organic film layer on a side of the buffer layer away from the substrate, providing an isolation layer between the organic film layer and the second end, providing a protective layer on the second end and a side of the metal wire away from the isolation layer, and providing a through hole in the buffer layer, the organic film layer, and the isolation layer by a fourth patterning process, in which the second end is connected to the PN junction through the through hole. According to an embodiment of the present disclosure, the fourth patterning process may also be a photolithography process to obtain through holes.

The principle of the temperature-controlled heating panel prepared by the method has been described in detail above and will not be repeated here.

In summary, a method for preparing a liquid crystal display panel array substrate is used to prepare structures such as the temperature sensing diode, the metal wire, the buffer layer, the organic film layer, the isolation layer, and the protective layer, so as to obtain the temperature-controlled heating panel which may achieve accurate control of the temperature above the environment temperature for a small area. The temperature-controlled heating panel has low production cost and is suitable for mass production. Moreover, the method for preparing the liquid crystal display panel array substrate can accurately control positions and shapes of the temperature sensing diode and the metal wire by multiple patterning processes, and allows the temperature sensing diode to be closer to the metal wire, thereby realizing precise temperature control and heating for a small area. In addition, the method may also provide an additional function to instruments used for preparing the display panel, for example, production instruments can be used to prepare the display panel and the temperature-controlled heating panel can be prepared by using same production instruments, thereby reducing the cost of enterprise on instruments.

In another aspect of the disclosure, the present disclosure provides a heating method using a temperature-controlled heating panel. According to an embodiment of the present disclosure, the temperature-controlled heating panel may be the temperature-controlled heating panel described above, thereby the temperature-controlled heating panel may have the features and advantages of the temperature-controlled heating panel described above, which will not be repeated here. According to an embodiment of the present disclosure, the temperature-controlled heating panel includes a substrate, a plurality of heating elements arranged in an array and provided on the substrate, a plurality of temperature sensing elements provided on the substrate and adjacent to the heating elements, and a controller.

According to an embodiment of the present disclosure, the method includes applying a current to the heating element by the controller, and adjusting the current applied by the controller to the heating element according to the temperature sensed by a temperature sensing element. Thereby, a precise control of the temperature above the environment temperature may be achieved for a small area by a simple method.

According to an embodiment of the present disclosure, the temperature controller includes the temperature control circuit 410 and the constant current circuit. The method specifically includes: applying a current to the heating element by using the temperature control circuit 410, the heating element generating heat after the current flowing through it, applying a constant current to the temperature sensing element by using the constant current circuit, and obtaining the temperature sensed by the temperature sensing element by detecting the voltage of the temperature sensing element, in which the temperature sensed by the temperature sensing element is the heating temperature of the heating element. The controller controls the temperature control circuit 410 to adjust the current applied to the heating element by comparing the temperature sensed by the temperature sensing element with the temperature to which the small area around the heating element needs to be heated up, thereby achieving a precise control of temperature. For example, according to an embodiment of the present disclosure, when the temperature sensed by the temperature sensing element is lower than the temperature to which the small area around the heating element needs to be heated up, the temperature control circuit 410 will increase the current applied to the heating element to increase the heating temperature. When the temperature sensed by the temperature sensing element is higher than the temperature to which the small area around the heating element needs to be heated up, the temperature control circuit 410 may decreases the current applied to the metal wire to reduce the heating temperature. According to an embodiment of the present disclosure, the temperature-controlled heating panel can be used to heat a small area around the metal wire to a predetermined temperature, and the heating temperature can be adjusted at any time during the heating process.

In the description of the present disclosure, the orientation or positional relationship indicated by the terms “upper”, “lower”, etc., is based on the orientation or positional relationship shown in the drawings, and is merely for the convenience of describing the present disclosure and does not limit that the disclosure must be constructed and operated in a specific orientation. Therefore, this is not to be construed as limiting of the disclosure.

In the description of the present specification, the terms “one embodiment”, “another embodiment” or the like means that specific features, structures, materials or characteristics described thereof are included in at least one embodiment of the present disclosure. In the present specification, the schematic representation of the above terms is not necessarily directed to the same embodiment or example. Furthermore, features, structures, materials, or characteristics described may be combined in a suitable manner in any one or more embodiments or examples. In addition, various embodiments or examples described in the specification, as well as features of various embodiments or examples, may be combined. In addition, it should be noted that in the present specification, the terms “first” and “second” are used for descriptive purposes only, and are not to be construed as indicating or implying a relative importance or implicitly indicating the number of technical features indicated.

While the embodiments of the present disclosure have been shown and described above, it is understood that the above-described embodiments are illustrative and are not to be construed as limiting the scope of the disclosure. Variations, modifications, substitutions and variations of the above-described embodiments may be made by those skilled in the art within the scope of the present disclosure.

What is claimed is:

1. A temperature-controlled heating panel, comprising:
a substrate;
at least one heating element provided in a first region on the substrate;
at least one temperature sensing element provided in a second region different from the first region on the substrate and located in a heat radiation area of the at least one heating element for sensing a temperature of the heat radiation area; and
a controller configured to control, based on the temperature of the heat radiation area sensed by the at least one temperature sensing element, the temperature of the heat radiation area by using the at least one heating element.

2. The temperature-controlled heating panel according to claim 1, wherein the at least one heating element comprises a plurality of heating elements and the at least one temperature sensing element comprises a plurality of temperature sensing elements, and
the plurality of heating elements are arranged in an array on the substrate and the plurality of the temperature sensing elements are arranged in an array on the substrate.

3. The temperature-controlled heating panel according to claim 2, wherein the plurality of heating elements comprise a first heating element, a second heating element, a third heating element, and a fourth heating element provided on the substrate and equally spaced apart from each other:
the plurality of temperature sensing elements comprise a first temperature sensing element, a second temperature sensing element, a third temperature sensing element, and a fourth temperature sensing element arranged in an array; and
the first temperature sensing element is provided between the first heating element and the second heating element, the second temperature sensing element and the third temperature sensing element are provided between the second heating element and the third heating element, and the fourth temperature sensing element is provided between the third heating element and the fourth heating element.

4. The temperature-controlled heating panel according to claim 1, wherein the controller comprises a temperature control circuit connected to the at least one heating element and configured to adjust a current applied to the at least one heating element.

5. The temperature-controlled heating panel according to claim 1, wherein the heat radiation area of each of the at least one heating element is in a range from 0.5 mm² to 1.5 mm².

6. The temperature-controlled heating panel according to claim 5, wherein the heat radiation area of each of the at least one heating element is in a range from 0.8 mm×0.8 mm to 1.2 mm×1.2 mm.

7. The temperature-controlled heating panel according to claim 1, wherein the at least one heating element each is a metal wire and is arranged on the substrate in a meander line shape or strip-shape.

8. The temperature-controlled heating panel according to claim 7, wherein a width of an orthographic projection of the metal wire on the substrate is in a range from 0.7 mm to 1.1 mm.

9. The temperature-controlled heating panel according to claim 1, wherein each of the at least one temperature sensing element is a temperature sensing diode, and the temperature sensing diode comprises:
a first end provided on the substrate;
a PN junction provided on a side of the first end away from the substrate; and
a second end provided on a side of the PN junction away from the first end.

10. A temperature-controlled heating panel according to claim 9, wherein each of the at least one heating element is a metal wire, and the metal wire is provided on a same layer as the second end.

11. The temperature-controlled heating panel according to claim 9, wherein the controller further comprises:
a constant current circuit comprising a constant current source, two ends of the constant current source being respectively coupled to the first and second ends of the at least one temperature sensing diode for applying a constant current to the at least one temperature sensing diode.

12. The temperature-controlled heating panel according to claim 11, wherein the constant current circuit further comprises a voltage detecting element having a first end and a second end, and the first end and the second end of the voltage detecting element are respectively connected to the first end and the second end of the at least one temperature sensing diode for sensing a voltage of the at least one temperature sensing diode.

13. The temperature-controlled heating panel according to claim 10, further comprising: a buffer layer, an organic film layer, and an isolation layer provided on the substrate comprising the PN junction; and a protective layer provided on the second end and the metal wire, wherein
the second end is connected to one end of the PN junction via a through hole provided in the buffer layer, the organic film layer, and the isolation layer.

14. The temperature-controlled heating panel according to claim 13, wherein the buffer layer, the isolation layer, and the protective layer are formed of nitrogen-silicon compound, and the organic film layer is formed of resin.

15. A method of preparing a temperature-controlled heating panel, comprising:
providing at least one heating element in a first region on a substrate;
providing at least one temperature sensing element in a second region different from the first region on the substrate, and the at least one temperature sensing element being provided in a heat radiation area of the at least one heating element for sensing a temperature of the heat radiation area; and
providing a temperature controller, the temperature controller being configured to control, based on the temperature of the heat radiation area sensed by the at least one temperature sensing element, the temperature of the heat radiation area by using the at least one heating element.

16. The method according to claim 15, wherein the at least one temperature sensing element is a temperature sensing diode comprising a first end, a PN junction, and a second end, and the at least one heating element is a metal wire;
providing the at least one heating element in the first region on the substrate and providing the at least one temperature sensing element in the second region different from the first region on the substrate comprises:
forming a first metal layer on the substrate, and forming, by a first patterning process, a pattern of the first end;
forming a first amorphous silicon layer and a second amorphous silicon layer sequentially on a side of the first end away from the substrate, and forming, by a second patterning process, a pattern of the PN junction; and
forming a second metal layer on a side of the PN junction away from the first end, and forming, by a third patterning process, patterns of the second end and the metal wire such that the second end is connected to one end of the PN junction.

17. The method according to claim 16, wherein, after forming the pattern of the PN junction and before forming the patterns of the second end and the metal wire, the method further comprises:
forming a buffer layer, an organic film layer, and an isolation layer sequentially; and
forming a through hole in the buffer layer, the organic film layer, and the isolation layer to expose a portion of a top surface of the PN junction such that the second end is connected to one end of the PN junction via the through hole.

18. The method according to claim 17, wherein, after forming the patterns of the second end and the metal wire, the method further comprises forming a protective layer.

19. A heating method by using a temperature-controlled heating panel, wherein the temperature-controlled heating panel comprises:
a substrate;
at least one heating element provided in a first region on the substrate;
at least one temperature sensing element provided in a second region different from the first region on the substrate and located in a heat radiation area of the at least one heating element for sensing a temperature of the heat radiation area; and
a controller configured to control, based on the temperature of the heat radiation area sensed by the at least one temperature sensing element, the temperature of the heat radiation area by using the at least one heating element, and
the method comprises:
adjusting, by using the controller, a current applied to the at least one heating element based on the temperature of the heat radiation area sensed by the at least one temperature sensing element.

20. The heating method according to claim 19, wherein adjusting, by using the controller, a current applied to the at least one heating element based on the temperature of the heat radiation area sensed by the at least one temperature sensing element comprises:
increasing, by using a temperature control circuit in the controller, the current applied to the at least one heating element when the temperature of the heat radiation area sensed by the at least one temperature sensing element is lower than a temperature to which the heat radiation area needs to be heated; and
decreasing, by using the temperature control circuit, the current applied to the at least one heating element when the temperature of the heat radiation area sensed by the at least one temperature sensing element is higher than the temperature to which the heat radiation area needs to be heated.
